(19) United States
(12) Patent Application Publication
(10) Pub. No.: US 2018/0285820 A1
(43) Pub. Date: Oct. 4, 2018

(54) METHOD AND SYSTEM FOR SCHEDULING CONFERENCE SESSION

(71) Applicant: RingCentral, Inc., Belmont, CA (US)

(72) Inventor: Vlad Vendrow, Reno, NV (US)

(73) Assignee: RingCentral, Inc.

(21) Appl. No.: 15/474,720

(22) Filed: Mar. 30, 2017

(51) Int. Cl. G06Q 10/10; G06Q 10/02

(52) U.S. Cl. CPC G06Q 10/109; G06Q 10/02

(57) ABSTRACT

A conference server for scheduling a conference session is disclosed. The conference server may include a memory and at least one processor. The at least one processor may be configured to receive, from a user device, information associated with an image of an object; identify, based on the information, a conference room; and send a conference invitation to the user device, wherein the conference invitation is for scheduling the conference session at the conference room.

### TECHNICAL FIELD

The present disclosure relates to the field of conferencing systems and, more particularly, methods and systems for scheduling conference sessions.

### BACKGROUND

In a conferencing system, when a user wishes to schedule a conference session at a conference room, the user may send a request to a conference server identifying the conference room, for example, by the name and/or number of the conference room, and participants. The conference server may check the availability of the conference room, and if it is available, reserve the room for the requested conference, and send a conference invitation to the participants of the conference session. Generally, if a user prefers to schedule the conference session at a particular conference room, the user must specify the conference room designation, for example, number, in the request sent to the conference server. Similarly, if the user wishes to schedule the conference session with a particular participant, the user must specify the identifier of the participant, such as the participant's name, in the request sent to the conference server. When the user wishes to join an ongoing conference session that includes one or more participants at a conference room, the user may send a request to the existing participants for authorization to join in the conference session.

However, the user often does not have immediate knowledge of the conference room number, and would need to look up for the conference room number by either looking up the conference room information in the conferencing system or walking around the conference rooms to figure out the room number. Similarly, the user may not know the full name of a particular participant, and would need to look up the participant information before scheduling a conference session with the participant or requesting authorization to join an ongoing conference session with the participant. A conference scheduling mechanism that allows the user to schedule a conference session at a conference room without the knowledge of the conference room number or schedule a conference session with a participant without knowledge of the full name of the participant(s) is therefore desired.

### SUMMARY

In one disclosed embodiment, a conference server for scheduling a conference session is disclosed. The conference server comprises a memory and at least one processor. The at least one processor is configured to receive, from a user device, information associated with an image of an object; identify, based on the information, a conference room; and send a conference invitation to the user device, wherein the conference invitation is for scheduling the conference session at the conference room.

In another disclosed embodiment, a computer-implemented method for scheduling a conference session is disclosed. The computer-implemented method comprises receiving, from a user device, information associated with an image of an object; identifying, based on the information, a conference room; and sending a conference invitation to the user device, wherein the conference invitation is for scheduling the conference session at the conference room.

In another disclosed embodiment, a non-transitory computer readable medium is disclosed. The non-transitory computer readable medium stores a set of instructions that is executable by at least one processor of a conference server to cause the conference server to perform a method for scheduling a conference session. The method comprises receiving, from a user device, information associated with an image of an object; identifying, based on the information, a conference room; and sending a conference invitation to the user device, wherein the conference invitation is for scheduling the conference session at the conference room.

### BRIEF DESCRIPTION OF THE DRAWINGS

The accompanying drawings, which are incorporated in and constitute part of this disclosure, together with the description, illustrate and serve to explain the principles of various example embodiments.

FIG. 1 is a diagram of an example of a conferencing system in which various implementations described herein may be practiced.

FIG. 2 is a diagram of an example user device for implementing embodiments consistent with the present disclosure.

FIG. 3 is a diagram of an example conference server, consistent with the disclosed embodiments.

FIG. 4 is a flowchart of an example process for scheduling a conference session, in accordance with embodiments of the present disclosure.

FIG. 5 is a flowchart of an example process for joining a user in an ongoing conference session, in accordance with embodiments of the present disclosure.

### DETAILED DESCRIPTION

Reference will now be made in detail to the example embodiments implemented according to the present disclosure, the examples of which are illustrated in the accompanying drawings. Wherever possible, the same reference numbers will be used throughout the drawings to refer to the same or like parts.

The present disclosure arises from the realization that in a conference room scheduling system that provides conference services, such as scheduling conference sessions for users, a user may wish to join or schedule a conference session at a particular conference room when walking by the room without knowing the conference room number. The user may then wish to select a conference room by taking a picture of the conference room via a user device and sending the picture or some other designation for the picture, for example, location information determined by the user's device based on the picture or when it is taken, to a conference server for the scheduling system to schedule a conference session at the selected conference room. Further, a user may wish to schedule a conference session with a particular participant when seeing or passing by the participant without knowing the full name of the participant. The user may then wish to select the participant by taking a picture of the participant and sending the picture or some other designation for the picture, for example, the participants identification information determined by the user's device based on the picture or when it is taken, to the conference server to set up a conference session with the participant. In some embodiments, the user can join or schedule a conference using both a designator for the conference room and a feature of a participant at the conference room. In the present disclosure, the term “conference session” refers to a pre-scheduled meeting by the conferencing system that takes place at a physical room and includes a plurality of participants.

Advantageously, the disclosed embodiments allow a user to schedule conference sessions conveniently without having the knowledge of a name or number associated with the conference room or identifiers of conference participants. The disclosed embodiments further allow a user to join an ongoing conference session without having the knowledge of the conference room information or identifiers of conference participants of the ongoing conference session.

Example embodiments of the present disclosure provide methods and systems for scheduling conference sessions. Consistent with disclosed embodiments, a conference server may receive information associated with an image of an object from a user device and identify a conference room based on the information. The conference server may send a conference invitation to the user device scheduling a conference session at the conference room. For example, the image of the object may be a picture of the conference room, a picture of a participant of an ongoing conference session, or a picture of a user to be invited as a participant of the conference session.

The embodiments herein include computer-implemented methods, tangible non-transitory computer-readable mediums, and systems. The computer-implemented methods can be executed, for example, by at least one processor that receives instructions from a non-transitory computer-readable storage medium. Similarly, systems and devices consistent with the present disclosure can include at least one processor and memory, and the memory can be a non-transitory computer-readable storage medium. As used herein, a non-transitory computer-readable storage medium refers to any type of physical memory on which information or data readable by at least one processor can be stored. Examples include random access memory (RAM), read-only memory (ROM), volatile memory, nonvolatile memory, hard drives, CD ROMs, DVDs, flash drives, disks, and any other known physical storage medium. Singular terms, such as “memory” and “computer-readable storage medium,” can additionally refer to multiple structures, such a plurality of memories or computer-readable storage mediums. As referred to herein, a “memory” can comprise any type of computer-readable storage medium unless otherwise specified. A computer-readable storage medium can store instructions for execution by at least one processor, including instructions for causing the processor to perform steps or stages consistent with an embodiment herein. Additionally, one or more computer-readable storage mediums can be utilized in implementing a computer-implemented method. The term “computer-readable storage medium” should be understood to include tangible items and exclude carrier waves and transient signals.

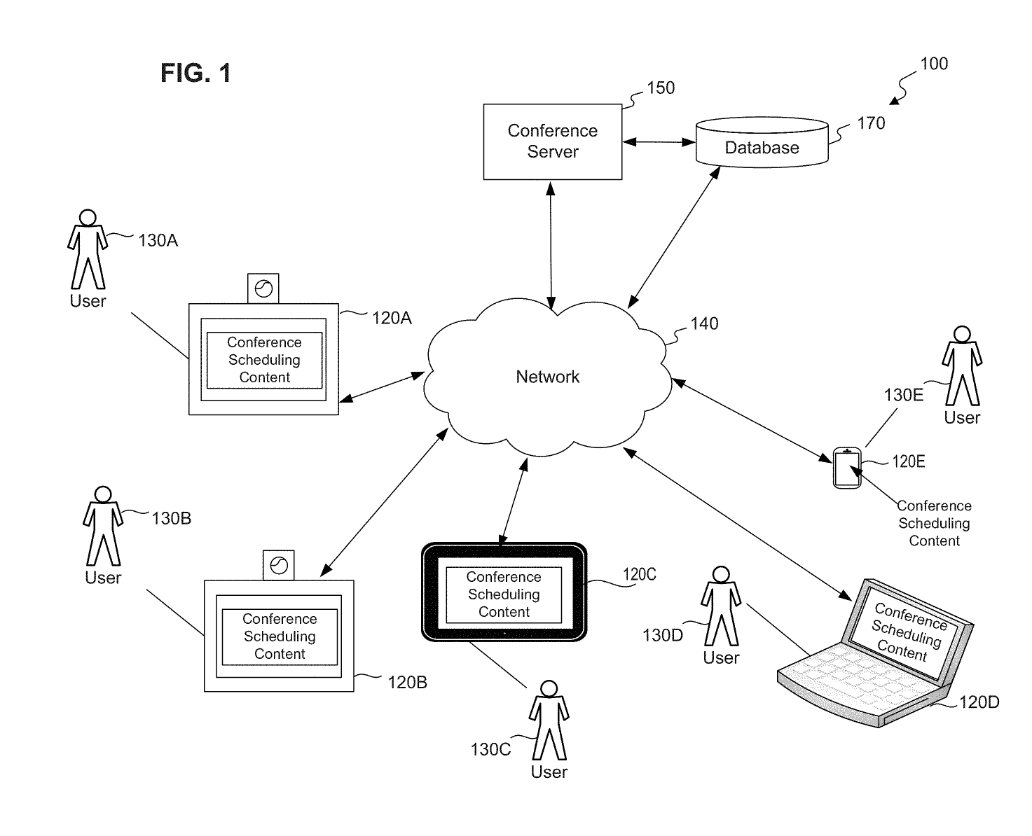

FIG. 1 shows an example of a conferencing system 100 in which various implementations as described herein may be practiced. Conferencing system 100 enables a plurality of users to set up conference sessions with one another via the associated user devices. In some examples, one or more components of conferencing system 100, such as conference server 150, can be used to implement computer programs, applications, methods, processes, or other software to perform the described techniques and to realize the structures described herein.

As shown in FIG. 1, conferencing system 100 includes one or more user devices 120A-120E (collectively as user devices 120), a network 140, a conference server 150, and a database 170. The components and arrangements shown in FIG. 1 are not intended to limit the disclosed embodiments, as the system components used to implement the disclosed processes and features can vary.

The network 140 facilitates communications and sharing of conference scheduling content between the user devices 120 and the conference server 150. The network 140 may be any type of networks that provides communications, exchanges information, and/or facilitates the exchange of information between the conference server 150 and user devices 120. For example, the network 140 may be the Internet, a Local Area Network, a cellular network, a public switched telephone network (“PSTN”), or other suitable connection(s) that enables conferencing system 100 to send and receive information between the components of conferencing system 100. A network may support a variety of electronic messaging formats, and may further support a variety of services and applications for user devices 120.

The conference server 150 can be a computer-based system including computer system components, desktop computers, workstations, tablets, hand held computing devices, memory devices, and/or internal network(s) connecting the components. The conference server 150 may be configured to provide conference services, such as setting up conference sessions for users 130A-130E. The conference server 150 may be configured to receive information from user devices 120 over the network 140, process the information, store the information, and/or transmit conference scheduling information to the user devices 120 over the network 140. For example, the conference server 150 may be configured to analyze images sent by users 130A-130E and identify conference rooms based on the images. The conference server 150 may send conference invitations to user devices 120A-120E, where the conference invitation schedules a conference session at a conference room. In some implementations, the functionality of the conference server 150 described in the present disclosure is distributed among one or more of the user devices 120A-120E. For example, one or more of the user devices 120A-120E may perform function such as identifying conference rooms based on the images of objects, and sending the conference invitations to other user devices.

The database 170 includes one or more physical or virtual storages coupled with the conference server 150. The database 170 is configured to store scheduled conference sessions and/or information of conference rooms, such as images of the conference rooms. The database may be adapted to store images of particular identifiers for the conference rooms, such as a unique furniture, equipment, or barcode. The database 170 may also be adapted to store contact information of the users 130 and/or images of the users 130. The data stored in the database 170 may be transmitted to the conference server 150 before scheduling a conference session or during an ongoing conference session. In some embodiments, the database 170 is stored in a cloud-based server (not shown) that is accessible by the conference server 150 and/or the user devices 120 through the network 140. While the database 170 is illustrated as an external device connected to the conference server 150, the database 170 may also reside within the conference server 150 as an internal component of the conference server 150.

As shown in FIG. 1, users 130A-130E may communicate with conference server 150 using various types of user devices 120A-120E via network 140. As an example, user devices 120A, 120B, and 120D include a display such as a television, tablet, computer monitor, video conferencing console, or laptop computer screen. User devices 120A, 120B, and 120D may also include video/audio input devices such as a video camera, web camera, or the like. As another example, user devices 120C and 120E include mobile devices such as a tablet or a smartphone having display and video/audio capture capabilities. User devices 120A-120E may also include one or more software applications that facilitate the user devices to engage in communications, such as IM, text messages, EMAIL, VoIP, video conferences, with one another.

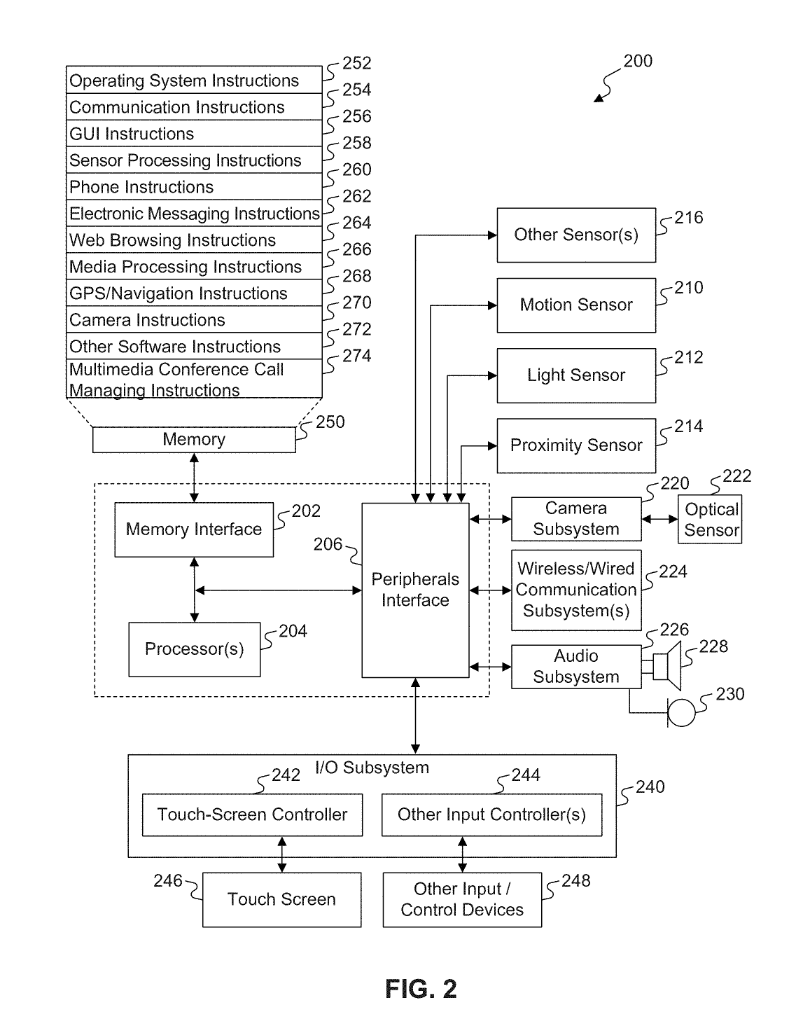

FIG. 2 is a diagram of an example of a user device 200 for use in a conferencing system, such as conferencing system 100. The user device 200 can be used to implement computer programs, applications, methods, processes, or other software to perform embodiments described in the present disclosure, such as the user devices 120A-120E. The user device 200 includes a memory interface 202, one or more processors 204 such as data processors, image processors and/or central processing units, and a peripherals interface 206. The memory interface 202, the one or more processors 204, and/or the peripherals interface 206 can be separate components or can be integrated in one or more integrated circuits. The various components in the user device 200 can be coupled by one or more communication buses or signal lines.

Sensors, devices, and subsystems can be coupled to the peripherals interface 206 to facilitate multiple functionalities. For example, a motion sensor 210, a light sensor 212, and a proximity sensor 214 can be coupled to the peripherals interface 206 to facilitate orientation, lighting, and proximity functions. Other sensors 216 can also be connected to the peripherals interface 206, such as a positioning system (e.g., GPS receiver), a temperature sensor, a biometric sensor, or other sensing device, to facilitate related functionalities. A GPS receiver can be integrated with, or connected to, the user device 200. For example, a GPS receiver can be built into mobile telephones, such as smartphone devices. GPS software allows mobile telephones to use an internal or external GPS receiver (e.g., connecting via a serial port or Bluetooth). A camera subsystem 220 and an optical sensor 222, e.g., a charged coupled device (“CCD”) or a complementary metal-oxide semiconductor (“CMOS”) optical sensor, may be utilized to facilitate camera functions, such as recording photographs and video clips.

Communication functions may be facilitated through one or more wireless/wired communication subsystems 224, which includes an Ethernet port, radio frequency receivers and transmitters and/or optical (e.g., infrared) receivers and transmitters. The specific design and implementation of the wireless/wired communication subsystem 224 depends on the communication network(s) over which the user device 200 is intended to operate. For example, in some embodiments, the user device 200 includes wireless/wired communication subsystems 224 designed to operate over a GSM network, a GPRS network, an EDGE network, a Wi-Fi or WiMax network, and a Bluetooth® network.

An audio subsystem 226 may be coupled to a speaker 228 and a microphone 230 to facilitate voice-enabled functions, such as voice recognition, voice replication, digital recording, and telephony functions.

The I/O subsystem 240 includes a touch screen controller 242 and/or other input controller(s) 244. The touch screen controller 242 is coupled to a touch screen 246. The touch screen 246 and touch screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 246. While a touch screen 246 is shown in FIG. 2, the I/O subsystem 240 may include a display screen (e.g., CRT or LCD) in place of the touch screen 246.

The other input controller(s) 244 is coupled to other input/control devices 248, such as one or more buttons, rocker switches, thumb-wheel, infrared port, USB port, and/or a pointer device such as a stylus. The touch screen 246 can, for example, also be used to implement virtual or soft buttons and/or a keyboard.

The memory interface 202 is coupled to memory 250. The memory 250 includes high-speed random access memory and/or non-volatile memory, such as one or more magnetic disk storage devices, one or more optical storage devices, and/or flash memory (e.g., NAND, NOR). The memory 250 stores an operating system 252, such as DRAWIN, RTXC, LINUX, iOS, UNIX, OS X, WINDOWS, or an embedded operating system such as VXWorkS. The operating system 252 can include instructions for handling basic system services and for performing hardware dependent tasks. In some implementations, the operating system 252 can be a kernel (e.g., UNIX kernel).

The memory 250 may also store communication instructions 254 to facilitate communicating with one or more additional devices, one or more computers and/or one or more servers. The memory 250 can include graphical user interface instructions 256 to facilitate graphic user interface processing; sensor processing instructions 258 to facilitate sensor-related processing and functions; phone instructions 260 to facilitate phone-related processes and functions; electronic messaging instructions 262 to facilitate electronic-messaging related processes and functions; web browsing instructions 264 to facilitate web browsing-related processes and functions; media processing instructions 266 to facilitate media processing-related processes and functions; GPS/navigation instructions 268 to facilitate GPS and navigation-related processes and instructions; camera instructions 270 to facilitate camera-related processes and functions; and/or other software instructions 272 to facilitate other processes and functions. The memory 250 may also include multimedia conference call managing instructions 274 to facilitate conference call related processes and instructions.

In some embodiments, the communication instructions 254 include software applications to facilitate connection with the conference server 150 that schedules conference sessions among a plurality of users. The electronic messaging instructions 262 may include a software program to generate conference scheduling requests to the conference server 150 for scheduling conference sessions. Further, the electronic messaging instructions 262 may include software applications to receive conference invitations from the conference server 150. The graphical user interface instructions 256 may include a software program that facilitates display of the conference invitations to a user associated with the user device and facilitates the user to provide user input, and so on.

In the presently described embodiment, the instructions cause the processor 204 to perform one or more functions of the disclosed methods. For example, the instructions may cause the camera subsystem 220 to capture an image of an object and cause the wireless communication subsystem(s) 224 to transmit the image to the conference server 150. In some embodiments, the instructions may cause the processors 204 to identify a conference room based on the image. For example, the processors 204 may be configured to identify the conference room based on a physical layout of the conference room shown in the image. As another example, the processors 204 may be configured to identify the conference room by performing a comparison between the image and pre-stored images in the memory 250.

Each of the above identified instructions and software applications may correspond to a set of instructions for performing one or more functions described above. These instructions need not be implemented as separate software programs, procedures, or modules. The memory 250 may include additional instructions or fewer instructions. Furthermore, various functions of the user device 200 may be implemented in hardware and/or in software, including in one or more signal processing and/or application specific integrated circuits.

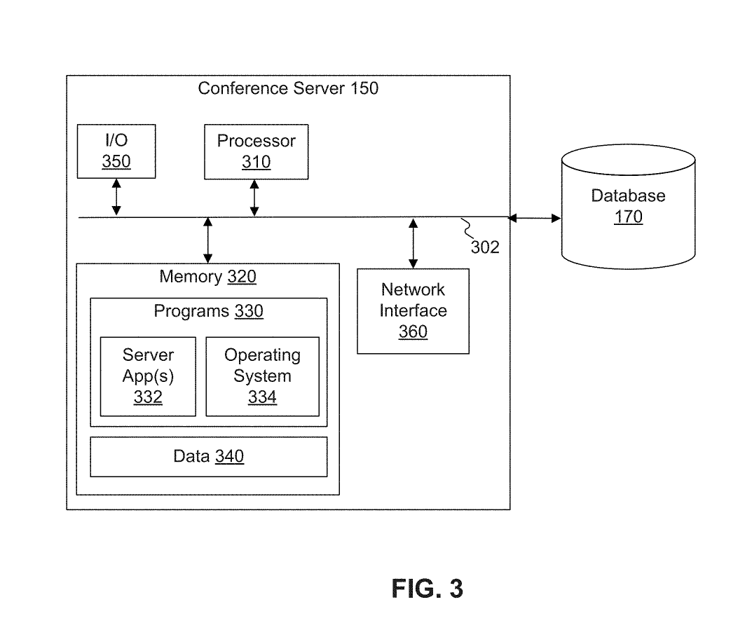

FIG. 3 shows a diagram of an example conference server 150, consistent with the disclosed embodiments. The conference server 150 includes a bus 302 (or other communication mechanism) which interconnects subsystems and components for transferring information within the conference server 150. As shown, the conference server 150 includes one or more processors 310, input/output (“I/O”) devices 350, network interface 360 (e.g., a modem, Ethernet card, or any other interface configured to exchange data with a network), and one or more memories 320 storing programs 330 including, for example, server app(s) 332, operating system 334, and data 340, and can communicate with an external database 170 (which, for some embodiments, may be included within the conference server 150). The conference server 150 may be a single server or may be configured as a distributed computer system including multiple servers, server farms, clouds, or computers that interoperate to perform one or more of the processes and functionalities associated with the disclosed embodiments.

The processor 310 may be one or more processing devices configured to perform functions of the disclosed methods, such as a microprocessor manufactured by Intel™ or manufactured by AMD™. The processor 310 may comprise a single core or multiple core processors executing parallel processes simultaneously. For example, the processor 310 may be a single core processor configured with virtual processing technologies. In certain embodiments, the processor 310 may use logical processors to simultaneously execute and control multiple processes. The processor 310 may implement virtual machine technologies, or other technologies to provide the ability to execute, control, run, manipulate, store, etc. multiple software processes, applications, programs, etc. In some embodiments, the processor 310 may include a multiple-core processor arrangement (e.g., dual, quad core, etc.) configured to provide parallel processing functionalities to allow the conference server 150 to execute multiple processes simultaneously. It is appreciated that other types of processor arrangements could be implemented that provide for the capabilities disclosed herein.

The memory 320 may be a volatile or non-volatile, magnetic, semiconductor, tape, optical, removable, non-removable, or other type of storage device or tangible or non-transitory computer-readable medium that stores one or more program(s) 330 such as server apps 332 and operating system 334, and data 340. Common forms of non-transitory media include, for example, a flash drive a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

The conference server 150 may include one or more storage devices configured to store information used by processor 310 (or other components) to perform certain functions related to the disclosed embodiments. For example, the conference server 150 may include memory 320 that includes instructions to enable the processor 310 to execute one or more applications, such as server apps 332, operating system 334, and any other type of application or software known to be available on computer systems. Alternatively or additionally, the instructions, application programs, etc. may be stored in an external database 170 (which can also be internal to the conference server 150) or external storage communicatively coupled with the conference server 150 (not shown), such as one or more database or memory accessible over the network 140.

The database 170 or other external storage may be a volatile or non-volatile, magnetic, semiconductor, tape, optical, removable, non-removable, or other type of storage device or tangible or non-transitory computer-readable medium. The memory 320 and database 170 may include one or more memory devices that store data and instructions used to perform one or more features of the disclosed embodiments. The memory 320 and database 170 may also include any combination of one or more databases controlled by memory controller devices (e.g., server(s), etc.) or software, such as document management systems, Microsoft SQL databases, SharePoint databases, Oracle™ databases, Sybase™ databases, or other relational databases.

In some embodiments, the conference server 150 may be communicatively connected to one or more remote memory devices (e.g., remote databases (not shown)) through network 140 or a different network. The remote memory devices can be configured to store information that the conference server 150 can access and/or manage. By way of example, the remote memory devices could be document management systems, Microsoft SQL database, SharePoint databases, Oracle™ databases, Sybase™ databases, or other relational databases. Systems and methods consistent with disclosed embodiments, however, are not limited to separate databases or even to the use of a database.

The programs 330 include one or more software modules configured to cause processor 310 to perform one or more functions of the disclosed embodiments. Moreover, the processor 310 may execute one or more programs located remotely from one or more components of the conferencing system 100. For example, the conference server 150 may access one or more remote programs that, when executed, perform functions related to disclosed embodiments.

In the presently described embodiment, server app(s) 332 causes the processor 310 to perform one or more functions of the disclosed methods. For example, the server app(s) 332 cause the processor 310 to receive conference scheduling requests or conference joining requests sent by a plurality of users, identify conference rooms based on images included in the conference scheduling requests or conference joining requests, and send conference invitations to user devices associated with the users for scheduling conference sessions. In some embodiments, other components of the conferencing system 100 may be configured to perform one or more functions of the disclosed methods. For example, user devices 120A-120E may be configured to analyze conference scheduling requests sent by a plurality of users and identify conference rooms based on images included in the conference scheduling requests.

In some embodiments, the program(s) 330 may include the operating system 334 performing operating system functions when executed by one or more processors such as the processor 310. By way of example, the operating system 334 may include Microsoft Windows™, Unix™, Linux™, Apple™ operating systems, Personal Digital Assistant (PDA) type operating systems, such as Apple iOS, Google Android, Blackberry OS, or other types of operating systems. Accordingly, disclosed embodiments may operate and function with computer systems running any type of operating system 334. The conference server 150 may also include software that, when executed by a processor, provides communications with network 140 through the network interface 360 and/or a direct connection to one or more user devices 120A-120E.

In some embodiments, the data 340 may include, for example, scheduling information of conference sessions, images of conference rooms, images of users, contact information of users, and so on. For example, the data 340 may include an album for each conference room, where the album includes a plurality of photographs of the conference room showing various areas of the conference room.

The conference server 150 may also include one or more I/O devices 350 having one or more interfaces for receiving signals or input from devices and providing signals or output to one or more devices that allow data to be received and/or transmitted by the conference server 150. For example, the conference server 150 may include interface components for interfacing with one or more input devices, such as one or more keyboards, mouse devices, and the like, that enable the conference server 150 to receive input from an operator or administrator (not shown).

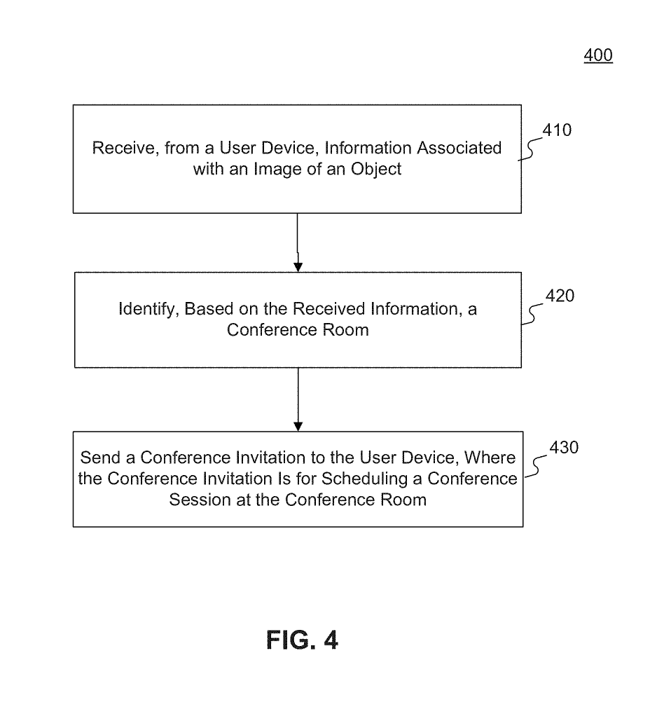

FIG. 4 is a flowchart of an example process 400 for scheduling a conference session, in accordance with embodiments of the present disclosure. The steps associated with this example process may be performed by, for example, a processor of the conference server 150 of FIG. 1. The example process 400 allows a user to schedule a conference session at a conference room by taking a picture of an object. For example, when a user takes a photograph of a conference room using a user device (e.g., the user device 120) and sends the photograph to the conference server 150, the conference server 150 may identify the conference room based on the photograph and schedules a conference session at the conference room. As another example, when a user takes a photograph of a conference room using a user device 120, the user device may identify location information of the user device 120 when the photograph is taken and send the location information to the conference server, and the conference server may identify the conference room based on the location information and schedules a conference session at the conference room.

In step 410, the conference server receives, from a user device, information associated with an image of an object. For example, the conference server may receive the image as an attachment to an EMAIL. As another example, the conference server may receive the image in an instant message sent by the user device. Methods known by persons skilled in the art may be used to receive the image from the user device without departing the scope of the present disclosure. The present disclosure does not intend to limit the manner used to receive the image from the user device.

In some embodiments, the image may be a photograph of a conference room. For example, a user of the user device may capture a photograph of the conference room when walking by the conference room. In other embodiments, the image may be a photograph of another user. For example, a user of the user device may capture a photograph of another user when meeting with the other user. In other embodiments, the image may be a photograph of both a conference room and another user. For example, a user of the user device may capture a photograph of another user in a conference room when passing by the conference room.

In some embodiments, the received information may include coordinates of the user device when the image of the object is captured by the user device. For example, the received information may include GPS coordinates of the user device when the image is captured. In some embodiments, the received information may include a hashtag corresponding to the image of the object. In some embodiments, the received information may include an image of a particular identifier for the conference room, such as a unique furniture, equipment, or barcode.

In step 420, the conference server identifies a conference room based on the received information. For example, when the received information is a photograph of a conference room, the conference server may identify the conference room based on a physical layout of the conference room shown in the image. The conference server may pre-store in a memory or retrieve from a database configurations of the conference rooms in the conferencing system. For example, the conference room configuration may specify the number of persons that can be accommodated in the conference room, the equipment installed in the conference room (e.g., the number of projectors, computers, phones, manufactures and models of devices), the furniture placed in the conference room and its location (e.g., the arrangement of the tables, chairs), and so on. The conference server may identify the physical layout of the conference room shown in the image and compare it with the configurations of the conference rooms to determine which conference room is shown in the image.

In some embodiments, when the received information is a photograph of a conference room, the conference server may identify the conference room by performing a comparison between the image and a number of pre-stored images. For example, the conference server may pre-store in a memory or retrieve from a database a plurality of images of the conference rooms. The conference server may identify an image in the pre-stored images that resembles the most to the conference room in the received image from the user device. In some embodiments, the conference server may process the image first before performing the comparison. For example, the conference server may remove the part of the image that does not represent the conference room, such as the hallway, the decoration outside the conference room, or the like. The conference server may utilize image recognition techniques to identify which pre-stored image resembles the most to the conference room in the received image, and the present disclosure does not intend to limit the manner used to identify the pre-stored image resembling to the conference room in the received image. After identifying the pre-stored image that resembles the most to the conference room in the received image, the conference server may retrieve the conference room information associated with the pre-stored image, such as conference room number, location, availability, and use this information to schedule a conference session.

In some embodiments, when the received information is a photograph of a user, the conference server may identify the user by performing a comparison between the image and a number of pre-stored images. For example, the conference server may pre-store in a memory or retrieve from a database a plurality of images of users of the conferencing system. The conference server may identify an image in the pre-stored images that resembles the most to the user in the received image from the user device. In some embodiments, the conference server may process the image first before performing the comparison. For example, the conference server may remove the part of the image that does not represent the user, such as the surrounding environment, the accessories worn by the user, or the like. The conference server may utilize image recognition techniques to identify which pre-stored image resembles the most to the user in the received image, and the present disclosure does not intend to limit the manner used to identify the pre-stored image resembling to the user in the received image. After identifying the pre-stored image that resembles the most to the user in the received image, the conference server may acquire the user information associated with the pre-stored image, including the user name and an ongoing conference session the user is currently participating in. The conference server may further acquire the conference room information of the ongoing conference session the user is currently participating in.

In some embodiments, the image may include a photograph of a user in a conference room. The conference server may identify the conference room based on the part of image containing the conference room and/or identify the user based on the part of image containing the user. For example, the conference server may acquire the conference room information of the ongoing conference session the user is currently participating in and determine that it is the same conference room identified based on the part of image containing the conference room. When the conference room information of the ongoing conference session the user is currently participating in is different from the conference room identified based on the part of image containing the conference room, the conference server may determine whether the user occupies a greater portion of the received image than the conference room. If the user occupies a greater portion of the received image than the conference room, the conference server may use the conference room information of the ongoing conference session the user is currently participating in for scheduling the conference session. If the conference room occupies a greater portion of the received image than the user, the conference server may use the conference room identified based on the part of image containing the conference room for scheduling the conference session.

In some embodiments, when the received information includes coordinates of the user device, the conference server may identify the conference room based on the coordinates. For example, the conference server may store GPS coordinates of the conference rooms. In some embodiments, when the received information includes a hashtag corresponding to the image of the object, the conference server may identify the conference room based on the hashtag. For example, the conference server may store a plurality of hashtags corresponding to the conference rooms.

In step 430, the conference server sends a conference invitation to the user device, where the conference invitation is for scheduling a conference session at the conference room identified in step 420. For example, the conference server may send the conference invitation to the user device in an EMAIL. As another example, the conference server may send the conference invitation to the user device in an instant message. Methods known by persons skilled in the art may be used to send the conference invitation to the user device without departing the scope of the present disclosure. The present disclosure does not intend to limit the manner used to send the conference invitation to the user device.

In some embodiments, the conference invitation may designate a user associated with the user device as a participant of the conference session. For example, based on the user device from which the image is received, the conference server may identify a user in the conferencing system that is associated with the user device. As another example, based on a sender of the received image identified in an EMAIL or an instant message, the conference server may designate the sender of the image as a participant of the conference session.

In some embodiments, the conference invitation may receive a start time and an end time associated with the conference session from the user device. For example, along with the image, the user device may send a start time and an end time associated with the conference session to the conference server. The conference server may indicate the start time and end time of the conference session in the conference invitation.

In some embodiments, the conference server may receive the number of participants associated with the conference session from the user device. For example, if the conference room identified in step 420 does not accommodate the number of participants, the conference server may suggest, in the conference invitation sent to the user device, alternate conference room(s) within the vicinity that would accommodate the desired number of participants.

Sometimes, the conference server may be unable to identify a conference room based on the received image. The conference server may prompt the user to send additional pictures of the conference room to enhance identification of the conference room. In other examples, the conference server may ask the user, by way of the user device, questions about the conference room in order to determine the conference room the user intends to use for scheduling a conference.

In some embodiments, the conference room identified in step 420 may be unavailable during the time period indicated by the user device, and the conference invitation may suggest an alternative time for the conference session during which the conference room is available. The conference invitation may also suggest an alternative conference room that is available during the time period indicated by the user device for the conference session. For example, the conference server may identify an alternative conference room with the same size and equipment as the conference room identified in step 420 and suggest the alternative conference room in the conference invitation. As another example, the conference server may identify an alternative conference room that is located the closest to the conference room identified in step 420 and suggest the alternative conference room in the conference invitation.

In some embodiments, the conference server may receive a response from the user device after sending the conference invitation. For example, the conference server may receive a message from the user device indicating acceptance of the conference invitation. The conference server may then update an availability status of the conference room scheduled for the conference session as being reserved. The conference server may also store the received image and update the database to associate the conference room with the received image. As another example, the conference server may receive a message from the user device declining the conference invitation and indicating the image is associated with another conference room, and the conference server may then schedule the conference room at the other conference room. The conference server may subsequently store the received image and update the database to associate the other conference room with the received image. As another example, the conference server may receive a message from the user device declining the conference invitation and indicating an incorrect conference room is identified in the conference invitation.

The conference server may then repeat step 420 to identify a different conference room for the conference session.

In some embodiments, the conference server may identify two or more conference rooms in step 420 based on the received image. For example, there may be multiple conference rooms having the same layout as the conference room shown in the received image or resemble the conference room shown in the received image. The conference server may identify the two or more conference rooms in the conference invitation sent to the user device. For example, the conference server may provide the conference room information of each of the conference rooms, such as conference room number, location, equipment installed, in the conference invitation. The conference server may then receive a response from the user device selecting one of the conference rooms for the conference session. In some embodiments, the conference server may further determine a location of the user (for example, by checking the GPS coordinates of the user device), and identify the conference room having the closest proximity to the user as the conference room shown in the received image.

In some embodiments, when the information received in step 410 includes an image of a user of the conferencing system, the conference server may identify the contact information of the user and send the conference invitation to the user. For example, the conference invitation may designate the user as a participant of the conference session. The user in the image may be different from the sender of the image. For example, the conference server may send the conference invitation to both the user in the image and the sender of the image, where the conference invitation may designate both the user in the image and sender of the image as participants of the conference session. In some embodiments, the image received in step 410 may include a plurality of users of the conferencing system, and the conference server may identify the contact information of each user and send the conference invitation to each user in the image. For example, the conference invitation may designate the plurality of users in the image as participants of the conference session. In some embodiments, the conference server may receive a set of images from the user device, where the set of images include a plurality of users. The conference server may identify the plurality of users in the set of images and designate the users as participants of the conference session in the conference invitation.

In some embodiments, even though a single user is included in the image received in step 410, the conference server may not be able to distinguish two or more users based on the received image. For example, there may be multiple users sharing similar physical characteristics as the user shown in the received image. The conference server may identify two or more users in the conference invitation sent to the user device. For example, the conference server may provide information of each of the users, such as name, title, department, in the conference invitation. The conference server may then receive a response from the user device selecting one or more of the users for the conference session. As another example, the conference server may determine a location of the user device (for example, by checking the GPS coordinates of the user device) and locations of the possible users identified in the received image (for example, by checking the GPS coordinates of the corresponding user devices of the possible users). The conference server may then designate the user having the closest proximity to the user device as the participant of the conference session in the conference invitation.

In some implementations, some of the steps described in the example process 400 may be implemented by a user device, such as the user device 100 of FIG. 1. For example, the user device may identify the conference room based on the image of the object and send the conference room information to the conference server to schedule a conference session. The user device may also send conference invitations to other user devices to join the conference session after receiving the conference invitation from the conference server.

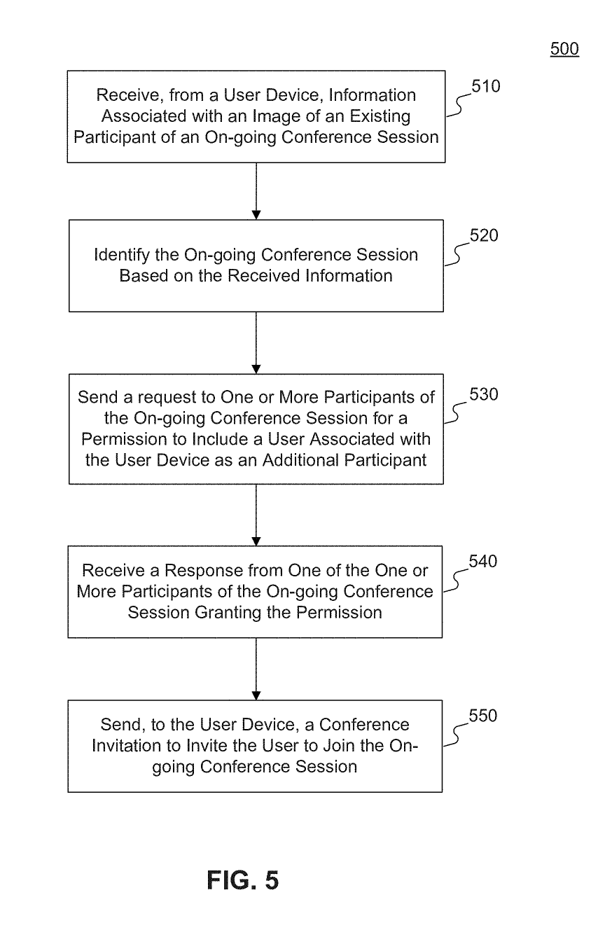

FIG. 5 is a flowchart of an example process 500 for joining a user in an ongoing conference session, in accordance with embodiments of the present disclosure. The steps associated with this example process may be performed by, for example, a processor of the conference server 150 of FIG. 1.

In step 510, the conference server receives from a user device, information associated with an image of an existing participant of an on-going conference session. An on-going conference is one that is live or currently in session. For example, a user passing by a conference room with an on-going conference session may take a photograph of a participant and send it to the conference server using the user device. As another example, the user device may determine an identifier of the participant based on the photograph and send the identifier to the conference server.

In step 520, the conference server identifies the on-going conference session based on the received information. For example, the conference server may identify the existing participant by performing a comparison between the received image and a number of pre-stored images, and then look up the existing participant in the conferencing system to identify the conference session the existing participant is currently attending. In some other examples, the user device may identify the existing participant based on the received identifier of the participant, and then look up the existing participant in the conferencing system to identify the conference session the existing participant is currently attending. As another example, the conference server may first identify users participating in an on-going conference session in the conferencing system, and compare the received image with images associated with these users who are participating in an on-going conference session. After the existing participant in the received image is identified, the conference server may acquire information of the on-going conference session the existing participant is currently attending.

In some embodiments, the conference server may further identify the role of the existing participant in the on-going conference session. For example, the conference server may identify whether the existing participant is an organizer of the on-going conference session by looking up information of the ongoing conference session in the conferencing system. If the existing participant is not an organizer of the on-going conference session, the conference server may identify the organizer of the on-going conference session.

In step 530, the conference server sends a request to one or more participants of the on-going conference session for permission to include a user associated with the user device as an additional participant. For example, the conference server may send the request for permission to the existing participant in the received image. As another example, the conference server may send the request for permission to each participant of the on-going conference session. In some embodiments, the conference server may send the request for permission to the organizer of the on-going conference session. For example, if the existing participant in the received image is identified as the organizer of the on-going conference session, the conference server may send the request for permission to the existing participant. If the existing participant in the received image is not the organizer of the on-going conference session, the conference server may send the request for permission to the organizer of the on-going conference session instead of the existing participant.

In some embodiments, the conference server may identify the number of participants and the size of the conference room associated with the on-going conference session.

If the conference room where the on-going conference session is currently held does not have enough room to accommodate the user as an additional participant, the conference server may suggest, in the request for permission, alternate conference room(s) within the vicinity that would accommodate the user as an additional participant.

In step 540, the conference server receives a response from one of the participants of the on-going conference session granting the permission to include the user as an additional participant. For example, the response may indicate that the user is authorized to join the on-going conference session and access materials distributed for the conference session. As another example, the response may indicate that the user is authorized to join the on-going conference session but with limited access to materials distributed for the conference session. In some implementations, the on-going conference session may be part of a recurring event, such as a weekly team meeting occurring at a certain time each week. The response may indicate whether the user is authorized to join the on-going conference session at this occurrence only or the user is authorized to join the future conference session occurrences in the series as well.

In step 550, the conference server sends, to the user device, a conference invitation to invite the user to join the on-going conference session. For example, the conference invitation may provide information of the on-going conference session, such as the conference room number, the participants of the conference session, the duration of the conference session, the subject of the conference session, or the like. As another example, if the user is granted access to materials distributed for the conference session, the conference invitation may include information of the conference materials. When the on-going conference session is part of a recurring event and the user is granted permission to join the future conference session occurrences, the conference invitation may provide information of the future conference session occurrences. On the other hand, when the on-going conference session is a recurring event and the user is only granted permission to join this conference session occurrence, the conference invitation may provide information of the this conference session occurrence only.

In some embodiments, the conference server may receive a response from one of the participants of the on-going conference session declining the permission to include the user as an additional participant. The response from one of the participants of the on-going conference session may also indicate the reason for declining the permission. The conference server may then send a message to the user indicating the request to join the on-going conference session is declined. In some implementations, the conference server may also identify the participant who declines the permission in the message to the user. If a reason for decline is indicated in the response from the participant who declines the permission, the conference server may also include the reason in the message to the user.

In some implementations, some of the steps described in the example process 500 may be implemented by a user device associated with a user, such as the user device 120 of FIG. 1. For example, one or more of the user devices 120A-120E may perform functions such as identifying the on-going conference session based on the image of the existing participant and sending a request to participants of the on-going conference session for a permission to include the user as an additional participant. As another example, a user device associated with the participants of the on-going conference session may send the conference invitation to invite the user to join the ongoing conference session.

In the preceding disclosure, various example embodiments have been described with reference to the accompanying drawings. It will, however, be evident that various modifications and changes may be made thereto, and additional embodiments may be implemented, without departing from the broader scope of the disclosure as set forth in the claims that follow. The disclosure and drawings are accordingly to be regarded in an illustrative rather than restrictive sense.

Therefore, it is intended that the disclosed embodiments and examples be considered as examples only, with a true scope of the present disclosure being indicated by the following claims and their equivalents.

1. A conference server for scheduling a conference session, the conference server comprising:
a memory; and
at least one processor configured to:
receive, from a user device, information associated with an image of a participant associated with a conference session;
determine whether the information comprises coordinates of the user device when the image was captured by the user device;
identify a conference room based on the coordinates when the information comprises the coordinates;
otherwise identify the conference room based on the image of the participant; and
send a request to one or more participants associated with the conference session for permission to add a user to the conference session.

2-4. (canceled).

5. The conference server of claim 1, wherein the at least one processor is further configured to:
receive a response from one or more participants associated with the conference session granting permission to add the user conference session; and
send, to the user device, a conference invitation to invite the user to join the conference session.

6. The conference server of claim 1, wherein the at least one processor is further configured to:
identify contact information of the participant associated with a conference session based on the image; and
send a conference invitation to the user, wherein the conference invitation designates the user as a participant of the conference session.

7-8. (canceled).

9. The conference server of claim 1, wherein the at least one processor is further configured to:
receive, from the user device, a start time and an end time associated with the conference session.

10. A computer-implemented method for scheduling a conference session, comprising:
receiving, from a user device, information associated with an image of a participant associated with a conference session;
determining whether the information comprises coordinates of the user device when the image was captured by the user device;
identifying a conference room based on the coordinates when the information comprises the coordinates;
otherwise identifying the conference room based on the image of the participant; and
sending a request to one or more participants associated with the conference session for permission to add a user to the conference session.

11-13. (canceled).

14. The computer-implemented method of claim 10, further comprising:
receiving a response from one or more participants associated with the conference session granting permission to add the user to the conference session; and
sending, to the user device, a conference invitation to invite the user to join the conference session.

15. The computer-implemented method of claim 10, the method further comprising:
identifying contact information of the participant associated with a conference session based on the image; and
sending a conference invitation to the user, wherein the conference invitation designates the user as a participant of the conference session.

16-17. (canceled).

18. The computer-implemented method of claim 10, further comprising:
receiving, from the user device, a start time and an end time associated with the conference session.

19. A non-transitory computer readable medium that stores a set of instructions that are executable by at least one processor of a conference server to cause the conference server to perform a method for scheduling a conference session, the method comprising:
receiving, from a user device, information associated with an image of a participant associated with a conference session;
determining whether the information comprises coordinates of the user device when the image was captured by the user device;
identifying a conference room based on the coordinates when the information comprises the coordinates;
otherwise identifying the conference room based on the image of the participant; and
sending a request to one or more participants associated with the conference session for permission to add a user to the conference session.

20. The non-transitory computer readable medium of claim 19, wherein the method further comprises:
receiving a response from one of the one or more participants associated with the conference session granting permission to add the user to the conference session;
sending, to the user device, a conference invitation to invite the user to join the conference session, wherein the conference invitation designates the user as a participant of the conference session; and
identifying contact information of the participant associated with a conference session based on the image.

21. The conference server of claim 1, wherein the conference session is associated with conference scheduling information and the request is for permission to add the user to the conference session associated with the conference scheduling information.

22. The computer-implemented method of claim 10, wherein the conference session is associated with conference scheduling information and the request is for permission to add the user to the conference session associated with the conference scheduling information.

23. The non-transitory computer readable medium of claim 19, wherein the conference session is associated with conference scheduling information and the request is for permission to add the user to the conference session associated with the conference scheduling information.
